(19) United States
(12) Patent Application Publication
(10) Pub. No.: US 2012/0272016 A1
(43) Pub. Date: Oct. 25, 2012

(54) MEMORY AFFINITIZATION IN MULTITHREADED ENVIRONMENTS

(75) Inventors: ADEKUNLE BELLO, Austin, TX (US); DOUGLAS JAMES GRIFFITH, Austin, TX (US); ANGELA ASTRID JAEHDE, Austin, TX (US); ARUNA YEDAVILLI, Austin, TX (US)

(73) Assignee: International Business Machines Corporation, Armonk, NY (US)

(21) Appl. No.: 13/092,840

(22) Filed: Apr. 22, 2011

(51) Int. Cl. G06F 12/00

(52) U.S. Cl. 711/154; 711/E12.001

(57) ABSTRACT

A method, system, and computer program product for memory affinitization in a multithreaded environment are provided in the illustrative embodiments. A first affinity domain formed in a computer receives from a second thread executing in a second affinity domain a request to access a unit of memory in the first affinity domain. The computer determines whether to migrate the unit of memory to the second affinity domain. The computer migrates, responsive the determining being affirmative, the unit of memory to the second affinity domain, thereby affinitizing the unit of memory with the second thread.

### TECHNICAL FIELD

The present invention relates generally to a computer implemented method, system, and computer program product for efficiently operating a multithreaded data processing environment. More particularly, the present invention relates to a computer implemented method, system, and computer program product for providing memory affinity for multithreaded applications in a data processing system.

### BACKGROUND

Data processing systems include memory devices for storing, processing, and moving data. A memory device, or memory, is generally a physical component of a data processing system configured to store data. A memory may also include logical or virtual components, such as a space on a hard disk designated to be used as a part of the memory.

Data processing systems can be configured in a variety of ways. For example, the components in a data processing system may be configured to operate in a manner such that parts of the data processing system behave as separate data processing units. The memory in such a configuration can be associated with a single data processing unit and can support transactions from the separate data processing units.

As another example, data processing systems can be divided into logical partitions (LPARs). Such data processing systems are also known as logical partitioned data processing systems. A logical partition is also known simply as a “partition.” Each partition operates as a separate data processing system independent of the other partitions. Generally, a partition management firmware component connects the various partitions and provides the network connectivity among them. A Hypervisor is an example of such partition management firmware.

Certain data processing systems, such as a multiprocessor system, can be configured to operate with several affinity domains. An affinity domain is an association of a processor and a memory space. The processor resources and the associated memory space resources of an affinity domain are preferentially utilized for the workloads scheduled to execute on the processor of the affinity domain.

Threads of a multithreaded application can execute on different processors in different affinity domains. When a thread executing in one affinity domain accesses memory associated with a different (foreign) affinity domain, the cost of such memory access is significantly higher as compared to accessing memory in the thread's own (local) affinity domain. Under certain circumstances, the overhead cost of accessing memory in a foreign affinity domain can be up to four times the cost of memory access in the local affinity domain.

For example, Non-Uniform Memory Access or Non-Uniform Memory Architecture (NUMA) is a computer memory design used in multiprocessor systems, where the memory access time depends on the memory location relative to a processor. Under NUMA, a processor can access its own local memory faster than non-local memory, that is, memory local to another processor or memory shared between processors.

### SUMMARY

The illustrative embodiments provide a method, system, and computer program product for memory affinitization in multithreaded environments. An embodiment includes a first affinity domain receiving from a second thread executing in a second affinity domain, a request to access a unit of memory in the first affinity domain. The first affinity domain is formed in a computer. The embodiment determines whether to migrate the unit of memory to the second affinity domain. The embodiment migrates the unit of memory to the second affinity domain in response to the determining being affirmative, thereby affinitizing the unit of memory with the second thread.

Another embodiment includes one or more computer-readable tangible storage devices and program instructions stored on at least one of the one or more storage devices. The program instructions include first program instructions to receive at a first affinity domain formed in a computer, from a second thread executing in a second affinity domain, a request to access a unit of memory in the first affinity domain. The program instructions further include second program instructions to make a determination whether to migrate the unit of memory to the second affinity domain. The program instructions further include third program instructions to migrate, responsive to the determination being affirmative, the unit of memory to the second affinity domain, thereby affinitizing the unit of memory with the second thread.

Another embodiment includes one or more processors, one or more computer-readable memories and one or more computer-readable tangible storage devices. The embodiment further includes program instructions, stored on at least one of the one or more storage devices, for execution by at least one of the one or more processors via at least one of the one or more memories. The program instructions include first program instructions to receive at a first affinity domain formed in a computer, from a second thread executing in a second affinity domain, a request to access a unit of memory in the first affinity domain. The program instructions further include second program instructions to make a determination whether to migrate the unit of memory to the second affinity domain. The program instructions further include third program instructions to migrate, responsive to the determination being affirmative, the unit of memory to the second affinity domain, thereby affinitizing the unit of memory with the second thread.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data processing system in which the illustrative embodiments may be implemented;

FIG. 2 depicts a block diagram of an example logical partitioned platform in which the illustrative embodiments may be implemented;

FIG. 3 depicts a block diagram of a mapping a memory associated with an affinity domain for performing memory affinitization in accordance with an illustrative embodiment;

FIG. 4 depicts a block diagram of an example memory migration for memory affinitization in accordance with an illustrative embodiment;

FIG. 5 depicts a block diagram of an example configuration for migrating a unit of memory for memory affinitization in accordance with an illustrative embodiment;

FIG. 6 depicts a block diagram of an example configuration for applying a page migration policy in accordance with an illustrative embodiment;

FIG. 7 depicts a block diagram of another example configuration for applying a page migration policy in accordance with an illustrative embodiment;

FIG. 8 depicts a flowchart of an example process of creating a heap for memory affinitization in accordance with an illustrative embodiment;

FIG. 9 depicts a flowchart of a process of page migration for memory affinitization in accordance with an illustrative embodiment; and

FIG. 10 depicts a flowchart of an example migration policy for memory affinitization in accordance with an illustrative embodiment.

### DETAILED DESCRIPTION

Presently, a first touch method of memory allocation is used to limit cross-affinity-domain memory access by threads. Cross-affinity-domain memory access is access by a thread executing in one affinity domain of memory associated with another affinity domain. The first touch method of memory allocation is a method in which memory is allocated to a thread from the memory associated with the affinity domain where the thread first begins to execute.

The invention recognizes that first touch method of memory allocation is insufficient to minimize cross-affinity-domain memory access related costs. For example, a thread of a multithreaded application may be allocated memory in the thread's local affinity domain when the thread begins execution, but the thread may be moved to another affinity domain at some point during the execution of the multithreaded application, causing the thread's access to the once-local memory become a cross-affinity-domain access.

Presently, certain threads can be bound to certain affinity domains to avoid cross-affinity-domain memory accesses. However, the invention recognizes that code support has to be built into the multithreaded application for enabling such thread-by-thread bindings.

The presently used methods were designed for addressing memory access issues when threads routinely moved from one affinity domain to another during the life of the thread. The invention recognizes that an emerging trend in large-scale multiprocessor systems is that threads are unlikely to move from one affinity domain to another during the life of the thread.

The invention further recognizes that if threads maintain their affinity to one affinity domain, the first touch method of memory allocation is insufficient for minimizing cross-affinity-domain memory accesses. As an example, a thread of a multithreaded application may be allocated memory in the thread's local affinity domain when the thread begins execution, but another thread of the multithreaded application may need to reference the first thread's memory, resulting in a cross-affinity-domain access.

The illustrative embodiments used to describe the invention generally address and solve the above-described problems and other problems related to cross-affinity-domain memory access overheads in multithreaded environments. The illustrative embodiments provide a method, system, and computer program product for memory affinitization in multithreaded environments. Memory affinitization is a process according to an embodiment that enables moving a page of memory located in a foreign affinity domain's memory to a local affinity domain's memory.

According to an embodiment of the invention, a thread is allocated a page in a memory associated with the thread's local affinity domain. When another thread performs a cross-affinity-domain memory access to the first thread's page, an embodiment evaluates whether moving the page to the second thread's local affinity domain is warranted. If warranted, an embodiment determines how to move the page and when to move the page. An embodiment further provides a mechanism for coordinating the move of pages of memory from one affinity domain to another.

The illustrative embodiments are described with respect to certain data and data structures only as examples. Such descriptions are not intended to be limiting on the invention. For example, an illustrative embodiment described with respect to a page of memory can be implemented with a smaller or larger unit of memory within the scope of the invention.

Furthermore, the illustrative embodiments may be implemented with respect to any type of data, data source, or access to a data source over a data network. Any type of data storage device may provide the data, such as a migration policy, to an embodiment of the invention, either locally at a data processing system or over a data network, within the scope of the invention.

The illustrative embodiments are further described with respect to certain applications only as examples. Such descriptions are not intended to be limiting on the invention. An embodiment of the invention may be implemented with respect to any type of application, such as, for example, applications that are served, the instances of any type of server application, a platform application, a stand-alone application, an administration application, or a combination thereof.

An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

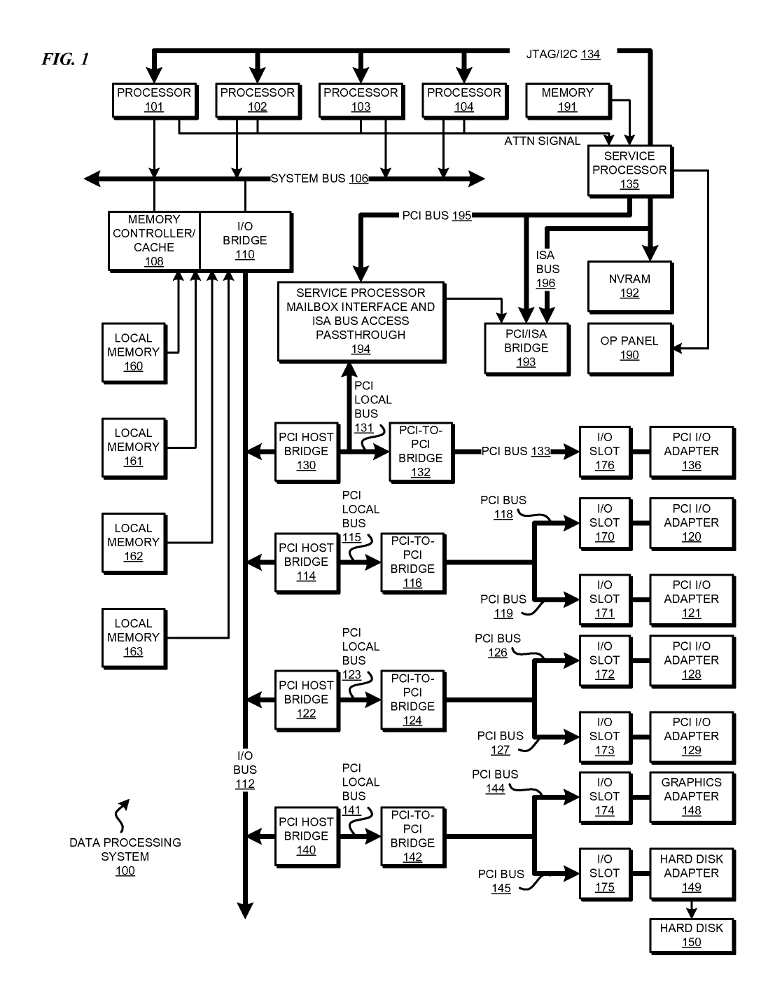

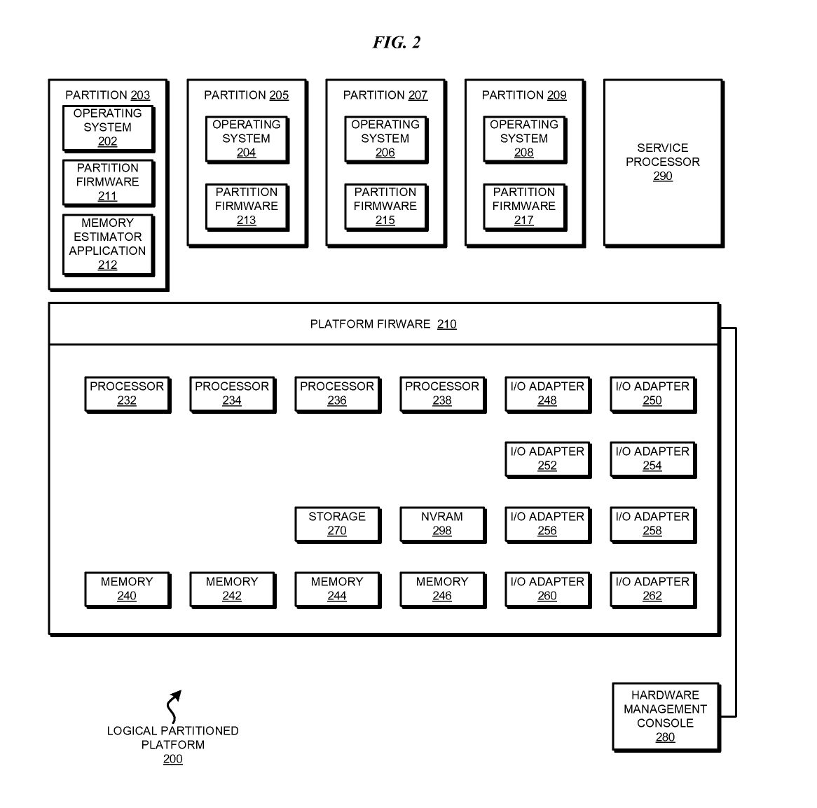

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

With reference to FIG. 1, this figure depicts a block diagram of a data processing system in which the illustrative embodiments may be implemented. Data processing system 100 may be a symmetric multiprocessor (SMP) system including a plurality of processors 101, 102, 103, and 104, which connect to system bus 106. For example, data processing system 100 may be an IBM Power System® implemented as a server within a network. (Power Systems is a product and a trademark of International Business Machines Corporation in the United States and other countries). Alternatively, a single processor system may be employed and processors 101, 102, 103, and 104 may be cores in the single processor chip. Alternatively, data processing system 100 may include processors 101, 102, 103, 104 in any combination of processors and cores.

Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 connects to a display device (not shown), while hard disk adapter 149 connects to and controls hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to one of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX®) operating system may be executing within partition P1, a second instance (image) of the AIX operating system may be executing within partition P2, and a Linux® or IBM-i® operating system may be operating within logical partition P3. (AIX and IBM-i are trademarks of International business Machines Corporation in the United States and other countries. Linux is a trademark of Linus Torvalds in the United States and other countries).

Peripheral component interconnect (PCI) host bridge 114 connected to I/O bus 112 provides an interface to PCI local bus 115. A number of PCI input/output adapters 120-121 connect to PCI local bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI local bus 123. PCI local bus 123 connects to a plurality of PCI I/O adapters 128-129. PCI I/O adapters 128-129 connect to PCI local bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

Memory mapped graphics adapter 148 is inserted into I/O slot 174 and connects to I/O bus 112 through PCI bus 144, PCI-to-PCI bridge 142, PCI local bus 141, and PCI host bridge 140. Hard disk adapter 149 may be placed into I/O slot 175, which connects to PCI bus 145. In turn, PCI bus 145 connects to PCI-to-PCI bridge 142, which connects to PCI host bridge 140 by PCI local bus 141.

A PCI host bridge 130 provides an interface for a PCI local bus 131 to connect to I/O bus 112. PCI I/O adapter 136 connects to I/O slot 176, which connects to PCI-to-PCI bridge 132 by PCI bus 133. PCI-to-PCI bridge 132 connects to PCI local bus 131. PCI local bus 131 also connects PCI host bridge 130 to service processor mailbox interface and ISA bus access pass-through logic 194 and PCI-to-PCI bridge 132.

Service processor mailbox interface and ISA bus access pass-through logic 194 forwards PCI accesses destined to PCI/ISA bridge 193. NVRAM storage 192 connects to ISA bus 196. Service processor 135 connects to service processor mailbox interface and ISA bus access pass-through logic 194 through its local PCI bus 195. Service processor 135 also connects to processors 101-104 via a plurality of JTAG/I2C busses 134. JTAG/I2C busses 134 are a combination of JTAG/scan busses (see IEEE 1149.1) and Phillips I2C busses.

However, alternatively, JTAG/I2C busses 134 may be replaced by only Phillips I2C busses or only JTAG/scan busses. All SP-ATTN signals of the host processors 101, 102, 103, and 104 connect together to an interrupt input signal of service processor 135. Service processor 135 has its own local memory 191 and has access to hardware OP-panel 190.

When data processing system 100 is initially powered up, service processor 135 uses the JTAG/I2C busses 134 to interrogate the system (host) processors 101-104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Service processor 135 gathers and reports any error information for failures detected during the BISTs, BATs, and memory tests.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. Service processor 135 monitors types of items including, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap.”

Data processing system 100 may be implemented using various commercially available computer systems. For example, data processing system 100 may be implemented using IBM Power Systems available from International Business Machines Corporation. Such a system may support logical partitioning using an AIX operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the illustrative embodiments.

With reference to FIG. 2, this figure depicts a block diagram of an example logical partitioned platform in which the illustrative embodiments may be implemented. The hardware in logical partitioned platform 200 may be implemented as, for example, the corresponding components depicted in data processing system 100 in FIG. 1.

Logical partitioned platform 200 includes partitioned hardware 230, operating systems 202, 204, 206, 208, and platform firmware 210. A platform firmware, such as platform firmware 210, is also known as partition management firmware. Operating systems 202, 204, 206, and 208 may be multiple copies of a single operating system or multiple heterogeneous operating systems simultaneously run on logical partitioned platform 200. These operating systems may be implemented using IBM-i, which is designed to interface with a partition management firmware, such as Hypervisor. IBM-i is used only as an example in these illustrative embodiments. Of course, other types of operating systems, such as AIX and Linux, may be used depending on the particular implementation. Operating systems 202, 204, 206, and 208 are located in partitions 203, 205, 207, and 209, respectively.

Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, partitions 203, 205, 207, and 209 also include partition firmware 211, 213, 215, and 217, respectively. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, platform firmware 210 loads a copy of boot strap code is loaded onto partitions 203, 205, 207, and 209. Thereafter, control is transferred to the boot strap code with the boot strap code then loading the open firmware and RTAS. The processors associated or assigned to the partitions are then dispatched to the partition's memory to execute the partition firmware.

Partition 203 includes migration application 212. Migration application 212 comprises program instructions for carrying out the processes of any of the various embodiments. The program instructions may be stored on at least one of one or more computer-readable tangible storage devices (e.g., hard disk 150, NVRAM 192, or a compact disk device coupled with I/O bus 112 in FIG. 1), for execution by at least one of one or more processors (e.g., processors 101-104 in FIG. 1) via at least one of one or more computer-readable memories (e.g., any of local memories 160-163). Migration application 212 may be implemented in any form, including but not limited to a form suitable for execution as a daemon, a form implemented using hardware and software, or a form suitable for integration into another application for memory management.

Partitioned hardware 230 includes a plurality of processors 232-238, a plurality of system memory units 240-246, a plurality of input/output (I/O) adapters 248-262, and a storage unit 270. Each of the processors 232-238, memory units 240-246, NVRAM storage 298, and I/O adapters 248-262 may be assigned to one of partitions 203, 205, 207, and 209 within logical partitioned platform 200, each of which partitions 203, 205, 207, and 209 corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of partitions 203, 205, 207, and 209 may be controlled through a hardware management console, such as hardware management console 280. Hardware management console 280 is a separate data processing system from which a system administrator may perform various functions including reallocation of resources to different partitions.

The hardware in FIGS. 1-2 may vary depending on the implementation. Other internal hardware or peripheral devices, such as flash memory, equivalent non-volatile memory, or optical disk drives and the like, may be used in addition to or in place of certain hardware depicted in FIGS. 1-2. An implementation of the illustrative embodiments may also use alternative architecture for managing partitions without departing from the scope of the invention.

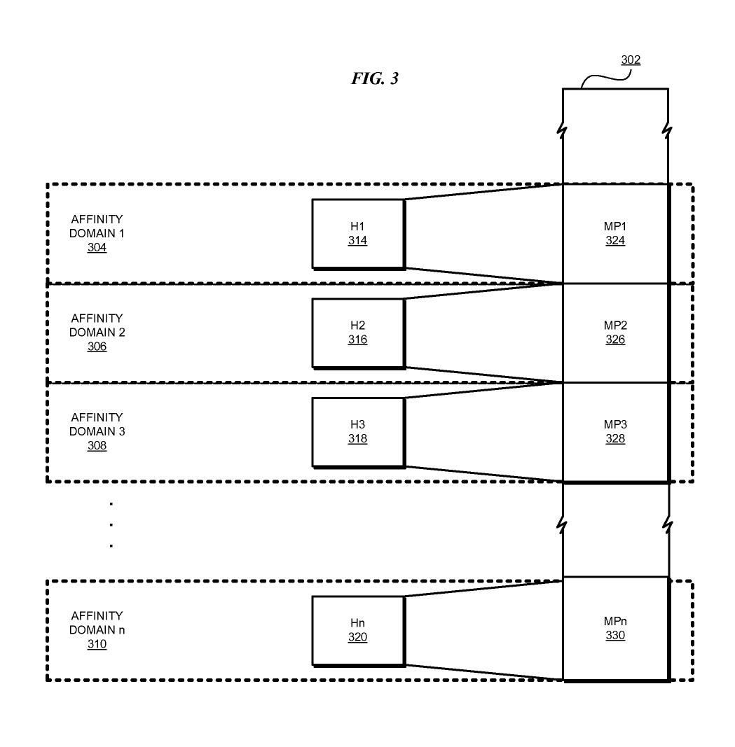

With reference to FIG. 3, this figure depicts a block diagram of a mapping a memory associated with an affinity domain for performing memory affinitization in accordance with an illustrative embodiment. Memory 302 may be all or part of memory units 240-246 in FIG. 2. Memories 324, 326, 328, and 330 are portions of memory 302 assigned in the manner described below. Affinity domain 304 labeled “Affinity Domain 1”, Affinity domain 306 labeled “Affinity Domain 2”, Affinity domain 308 labeled “Affinity Domain 3”, and Affinity domain 310 labeled “Affinity Domain n”, may each include one or more processors (not shown), such as any of processors 232-238 in FIG. 2. Any number of affinity domains may be used in an embodiment without limitation on the invention.

Heap 314 labeled “H1,” heap 316 labeled “H2,” heap 318 labeled “H3,” and heap 320 labeled “Hn,” are user state memory heaps generated for affinity domains 304, 306, 308, and 310 respectively. Taking affinity domain 304 as an example, heap 314 is mapped to memory 324 labeled “MP1” that is associated with affinity domain 304. Similarly, heap 316 is mapped to memory 326 labeled “MP2” that is associated with affinity domain 306, heap 318 is mapped to memory 328 labeled “MP3” that is associated with affinity domain 308, and heap 320 is mapped to memory 330 labeled “MPn” that is associated with affinity domain 310. Each of memories 324, 326, 328, and 330 is a kernel memory pool of a corresponding affinity domain 304, 306, 308, and 310.

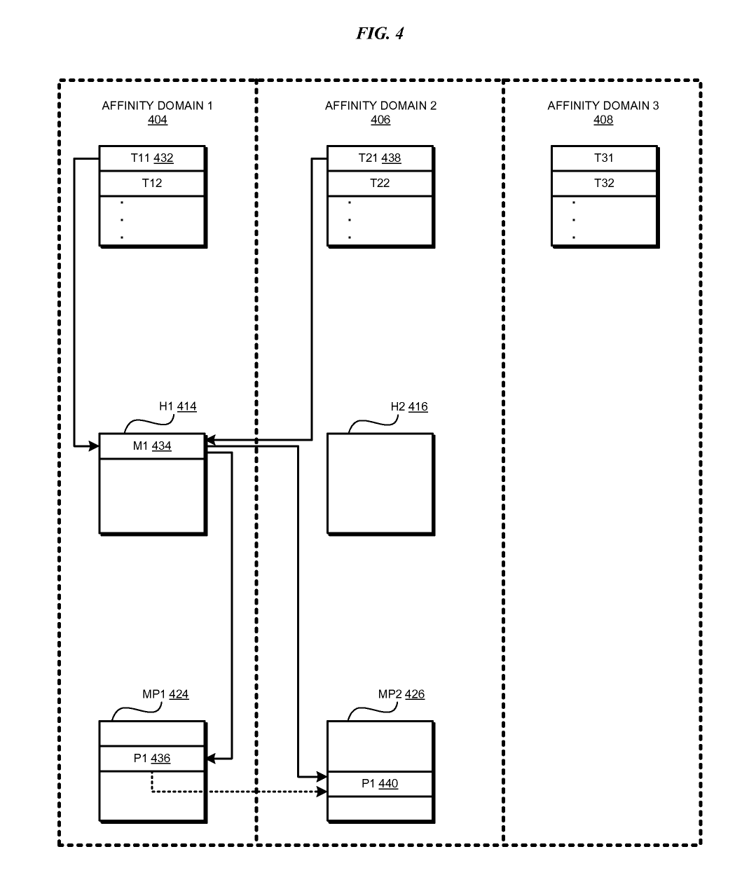

With reference to FIG. 4, this figure depicts a block diagram of an example memory migration for memory affinitization in accordance with an illustrative embodiment. Affinity domains 404, 406, and 408 correspond to affinity domains 304, 306, and 308 respectively in FIG. 3. Heaps 414 and 416 correspond to heaps 314 and 316 respectively in FIG. 3. Memory 424 corresponds to memory 324 and memory 426 corresponds to memory 326 in FIG. 3.

Memory allocations of a thread executing in an affinity domain are bound to the heap in that affinity domain. For example, thread 432 executing in affinity domain 404 is allocated memory 434 labeled “M1” from heap 414. Memory “M1” 434 maps to a unit of memory, for example, page 436 labeled “P1” in memory 424. Data used, created, stored, or otherwise manipulated by thread 432 is stored in page 436. A page of memory is used only as an example unit or quantum of memory. Any quantum of memory suitable for a particular implementation may be similarly used without departing the scope of the invention.

Thread 438 may be another thread executing in another affinity domain, such as affinity domain 406. Furthermore, threads 432 and 438 may share some data such that thread 438 may have to access thread 432's memory 434. This situation is common in a multithreaded application whose threads are executed on different processors in a machine for efficiency, parallelism, reliability, or other reasons.

Accordingly, thread 438 requests access to thread 432's data in page 436. Thread 438's request is directed to memory 434 in heap 414, which maps to page 436 in memory 424. Such a request incurs the large overhead cost described earlier because the request is a request for cross-affinity-domain memory access.

In accordance with an illustrative embodiment, a component in affinity domain 404 makes a determination whether page 436 should be moved from memory 424 to page 440 in memory 426 so that the access to the page becomes a local access for thread 438. Various embodiments described herein provide a variety of ways in which to determine whether such a migration of page 436 is warranted.

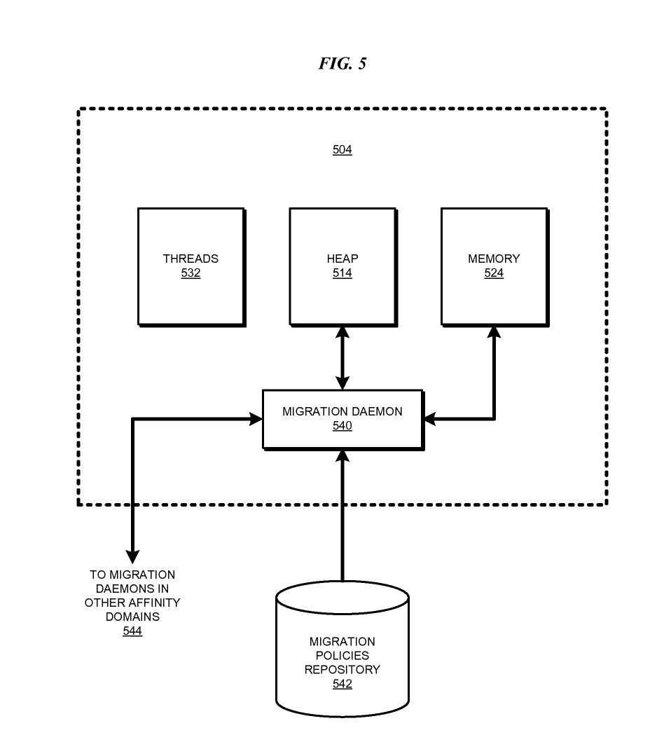

With reference to FIG. 5, this figure depicts a block diagram of an example configuration for migrating a unit of memory for memory affinitization in accordance with an illustrative embodiment. Affinity domain 504 is analogous to affinity domain 404 in FIG. 4. Heap 514 corresponds to heap 414 and memory 524 corresponds to memory 424 in FIG. 4. Threads 532 may be any number of threads executing in affinity domain 504.

Migration daemon 540 may be an embodiment of migration application 212 in FIG. 2. Migration daemon 540 may be a hardware or software component of affinity domain 504. Migration daemon 540 communicates with heap 514, memory 524, migration policies repository 542, and migration daemons 544 existing in other affinity domains.

When a thread from a foreign affinity domain, such as thread 438 in FIG. 4, accesses a page in memory 524 in affinity domain 504, a determination has to be made whether the page is a candidate for migration from affinity domain 504 to the foreign affinity domain of the requesting thread. In one embodiment, migration daemon 540 may make such determinations by using a set of policies from policy repository 542. A set of policies is one or more policies. A policy is specification of a rule or a condition, or a combination of several rules or conditions, which when satisfied, allows or disallows an operation.

An example page migration policy in repository 542 may provide that a page in a local affinity domain should be migrated to a foreign affinity domain if a number of cross-affinity-domain accesses for the page from the foreign affinity domain exceed a threshold. Such an example policy may be further modified. For example, a second example policy may allow the threshold to be predetermined for a set of threads, or determined on a thread-by-thread basis. A set of threads is one or more threads.

A third example policy that may allow the threshold to be determined comparatively with respect to another criterion. For example, the threshold may be a number of local accesses to the page during a period. The third example policy may provide that if the cross-affinity-domain access exceeds the local access count during a period, the page should be moved.

A fourth example policy may provide that even if the cross-affinity-domain access exceeds the local access count during a period, the page migration determination should be deferred until the expiration of the period. A fifth example policy may require that the number of cross-affinity-domain accesses be accumulated over a set of periods and compared to a threshold for remote accesses during the number of periods in the set. A set of periods is one or more periods.

A sixth example policy may require that the number of cross-affinity-domain accesses be accumulated over a set of periods and compared to a number of local accesses during the same set of periods. A seventh example policy may require that the number of cross-affinity-domain accesses be compared to a forecast number of local accesses.

An eighth example policy may provide the rule for selecting a foreign affinity domain to migrate the page when the page received cross-affinity-domain requests from more than one foreign affinity domains. These example policies are included here only for the clarity of the description and not as a limitation on the invention. Those of ordinary skill in the art will be able to define many more policies from this disclosure and the same are contemplated within the scope of the invention.

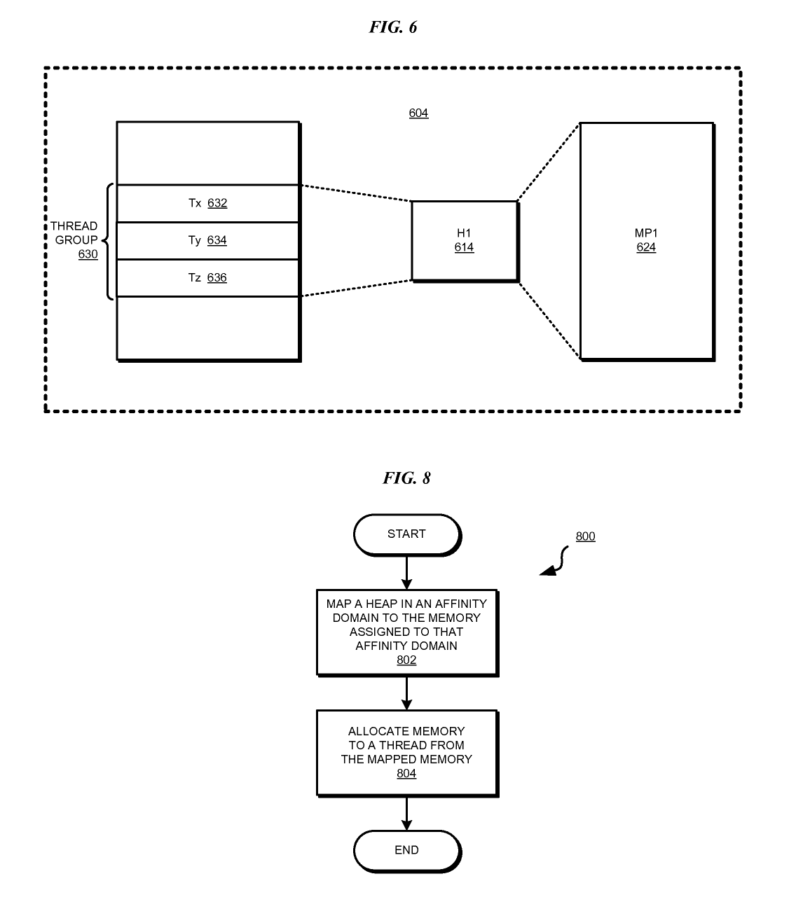

With reference to FIG. 6, this figure depicts a block diagram of an example configuration for applying a page migration policy in accordance with an illustrative embodiment. Affinity domain 604, heap 614, and memory 624 correspond to affinity domain 504, heap 514, and memory 524 respectively in FIG. 5.

In applying a policy, a migration application, such as migration application 212 in FIG. 2, may assign a set of threads belonging to certain processes to certain affinity domains. For example, thread group 630 may be a group of threads. Thread 632 labeled “Tx,” thread 634 labeled “Ty,” thread 636 labeled “Tz,” or any combination thereof, may be preferentially assigned to affinity domain 604 when those threads are launched. Grouping threads by policy in this manner allows, for example, avoiding cross-affinity-domain memory access among threads that are known to share data in memory.

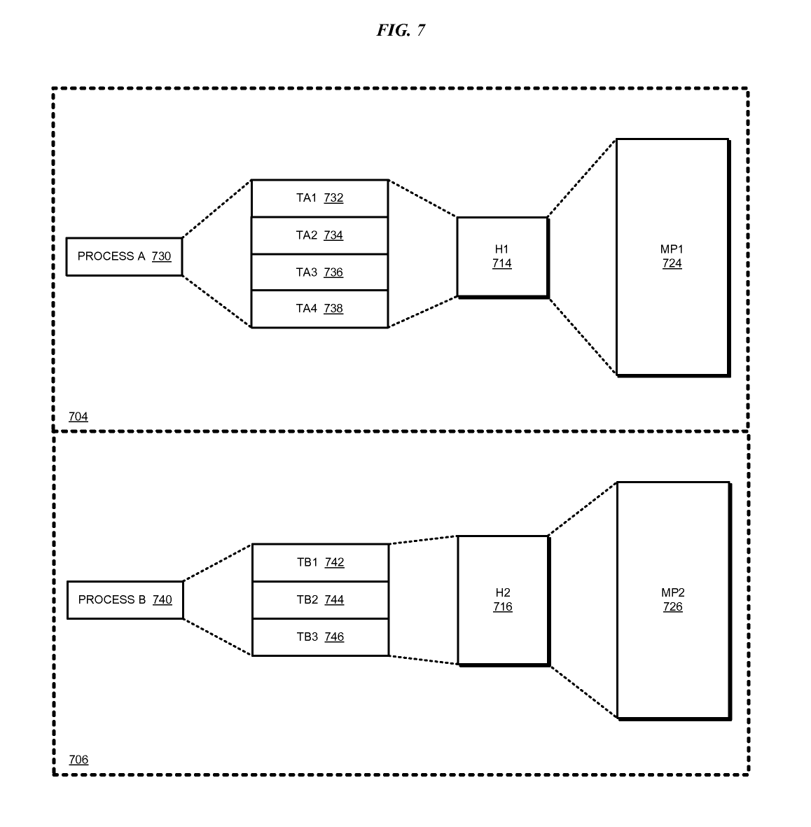

With reference to FIG. 7, this figure depicts a block diagram of another example configuration for applying a page migration policy in accordance with an illustrative embodiment. Affinity domain 704, heap 714, and memory 724 correspond to affinity domain 604, heap 614, and memory 624 respectively in FIG. 6. Affinity domain 706 may be another available affinity domain, including heap 716 and memory 726.

In applying a policy, a migration application, such as migration application 212 in FIG. 2, may assign certain processes to certain affinity domains. For example, process 730 may be a process designated to execute in affinity domain 704, if possible. Process 730 may spawn a set of threads, such as threads 732, 734, 736, and 738.

When possible, according to the policy, any of threads 732-738 will be executed in affinity domain 704. Process 740 and associated threads 742, 744, and 746 may similarly be designated to execute in affinity domain 706 when possible. Thus, a policy according to an embodiment may be utilized to help mitigate cross-affinity-domain memory access among threads of a process that is known to use data sharing between threads.

As an example, an implementation may perform memory affinitization according to an embodiment by activating a policy for migrating a page if the cross-affinity-domain access exceeds a threshold, and is globally applicable to all threads in all available affinity domains. The implementation may further use a second policy, which applies to certain groups of threads and attempts to keep the threads in the group together on one affinity domain. When the second policy is used in conjunction with the first policy, the second policy may supersede the first policy for the threads that are subject to the second policy. Similarly, when a third policy of keeping certain processes on certain affinity domains is in effect, the third policy may supersede any second or first policy that may affect the threads of those processes as well.

Thus, various embodiments not only provide for a variety of page migration policies, the embodiments also provide for selectively applying those policies as well. The depictions of FIGS. 6 and 7, and their corresponding description herein are not intended to be limiting on the invention. For example, a policy may similarly be configured to apply to all threads or processes executing in all available affinity domains. A policy may be configured to apply to only select threads or processes, select affinity domains, or a combination thereof. A policy may group certain threads or processes, assign the group or parts thereof to only certain affinity domains.

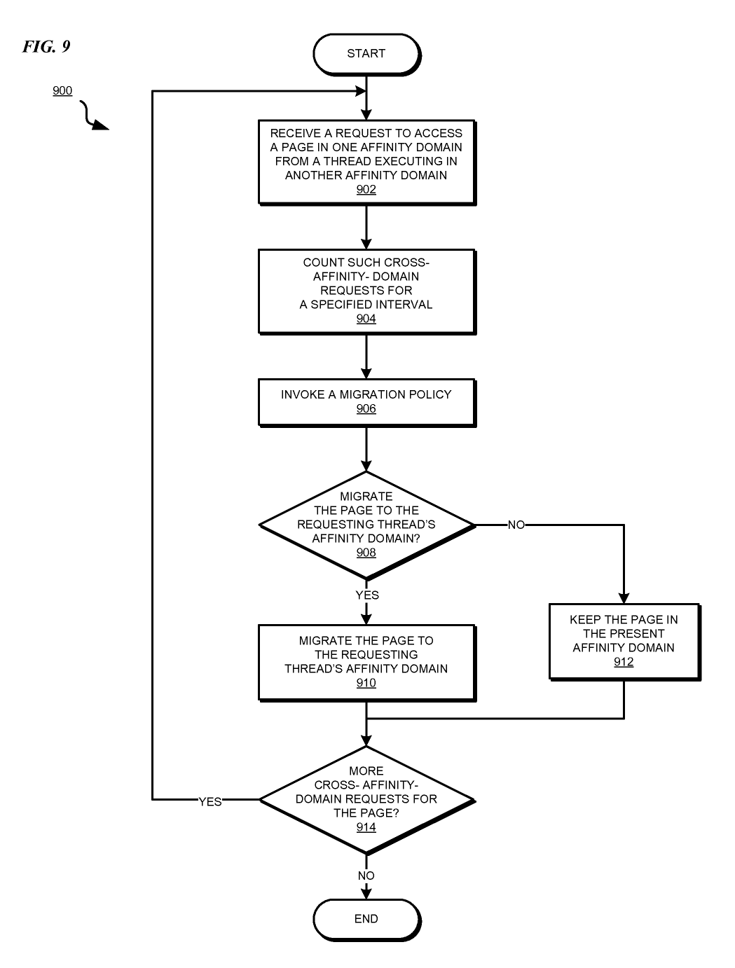

With reference to FIG. 8, this figure depicts a flowchart of an example process of creating a heap for memory affinitization in accordance with an illustrative embodiment. Process 800 may be implemented in an existing application for memory management, a migration application, such as migration daemon 540 in FIG. 5, or a combination thereof.

Using process 800, such a migration application maps a heap in an affinity domain to the memory assigned to that affinity domain (block 802). The migration application allocates memory to a thread in the affinity domain from the mapped memory (block 804). Process 800 may end thereafter or continue monitoring for additional memory requests from threads in the affinity domain.

With reference to FIG. 9, this figure depicts a flowchart of a process of page migration for memory affinitization in accordance with an illustrative embodiment. Process 900 may be implemented in a manner similar to process 800 in FIG. 8, such as in a migration application, for example, migration daemon 540 in FIG. 5.

Using process 900, a migration application receives a request to access a page in one affinity domain (local affinity domain) from a thread executing in another affinity domain (foreign affinity domain) (block 902). The migration application counts such cross-affinity-domain memory access requests for a specified interval (block 904). The migration application invokes a migration policy, such as those described with respect to FIGS. 5-7 (block 906).

According to the policy of block 906, the migration application determines whether to migrate the page to the requesting thread's affinity domain (block 908). If the page of memory should be migrated (“Yes” path of block 908), the migration application migrates the page to the requesting thread's affinity domain (block 910). If the page should not be migrated (“No” path of block 908), the migration application keeps the page in the present affinity domain (block 912).

The migration application determines whether more cross-affinity-domain requests should be monitored for the page (block 914). For example, process 900 may monitor and count such request for additional periods for making the migration determination according to certain migration policies. If more requests are to be counted (“Yes”' path of block 914), the migration application returns to block 902 of process 900. If no more cross-affinity-domain requests are to be counted (“No” path of block 914), process 900 ends thereafter.

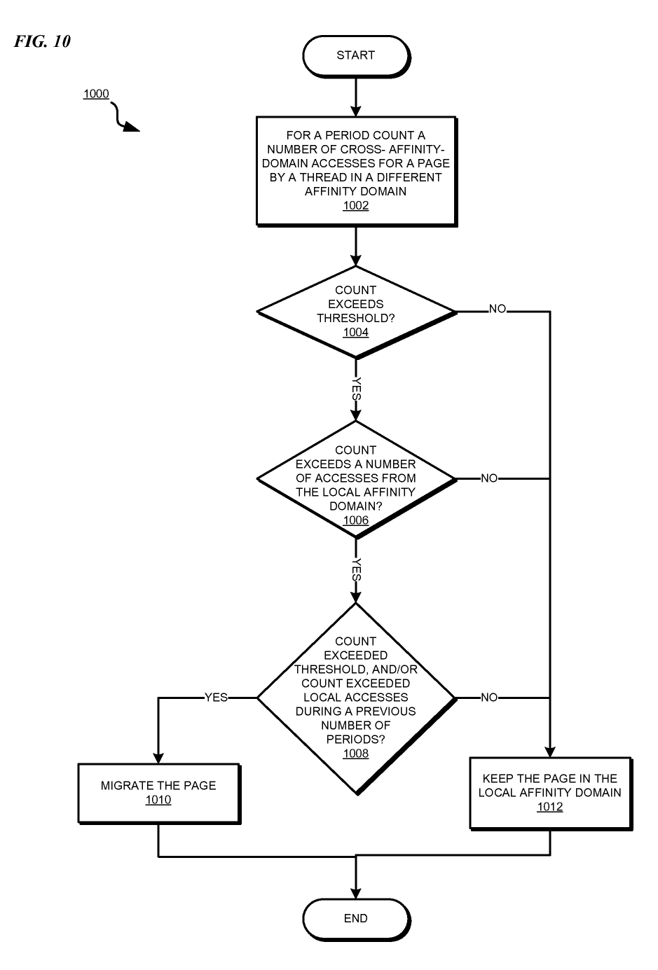

With reference to FIG. 10, this figure depicts a flowchart of a process of using an example migration policy for memory affinitization in accordance with an illustrative embodiment. Process 1000 may be implemented in the manner of processes 800 and 800 in FIGS. 8 and 9 respectively, such as in a migration application, for example, migration daemon 540 in FIG. 5.

Using process 1000, the migration application counts, for a period, a number of cross-affinity-domain accesses for a page by a thread in a different affinity domain (block 1002). Process 1000 determines whether the count has exceeded a threshold (block 1004). If the count has exceeded a threshold (“Yes” path of block 1004), the migration application further determines whether the count exceeds a number of accesses for the page from the local affinity domain (block 1006).

If the count exceeds the number of local accesses (“Yes” path of block 1006), the migration application may, optionally, further determine whether the count exceeded the threshold, and/or the count had exceeded the threshold or the number of local accesses during a previous number of periods as well (block 1008). For example, the migration application may compute and evaluate a cumulative count of cross-affinity-domain accesses over a set of periods in block 1008.

If the determination in block 1008 is affirmative (“Yes” path of block 1008), or when block 1008 is optional and the determination in block 1006 is affirmative, the migration application decides to migrate the page to the foreign affinity domain from where the cross-affinity-domain requests originated (block 1010) (optional “Yes” path of block 1006 to block 1010 not shown). Migrating a page of memory or another unit/quantum of memory may be accomplished in any manner suitable to an implementation. For example, the migration may be accomplished by simply copying the contents of the page from the memory of the local affinity domain to the memory of the foreign affinity domain.

If the determination of block 1008 is negative (“No” path of block 1008), the migration application decides to keep the page in the present local affinity domain (block 1012). If the determination of blocks 1004 or 1006 are negative (“No” path of block 1004) and (“No” path of block 1006), process 1000 ends thereafter as well.

The various embodiments, block diagrams, flowcharts, and examples are described using one heap only as an example. An embodiment is not intended to imply a limitation on the invention that only one heap may be created per affinity domain. A heap is associated with a process. If a process is distributed such that the process' threads execute in multiple affinity domains, each such affinity domain will have a heap corresponding to that process. There can be any number of processes executing in this manner in a given set of affinity domains. Therefore, a particular affinity domain in the set can have any number of heaps, each heap associated with at least one process whose thread is executing in that affinity domain.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for memory affinitization in multithreaded environments. Using an embodiment of the invention, a data processing system with multiple affinity domains and executing a multithreaded application can avoid, minimize, or mitigate some or all of the cross-affinity-domain memory accesses. When an operation, policy, or migration according to an embodiment is not possible or permitted for any reason, an embodiment does not increase the cost cross-affinity-domain memory accesses.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for memory affinitization in a multithreaded environment, the method comprising:
a first affinity domain formed in a computer receiving, from a second thread executing in a second affinity domain, a request to access a unit of memory in the first affinity domain;
the computer determining whether to migrate the unit of memory to the second affinity domain; and
the computer migrating, responsive the determining being affirmative, the unit of memory to the second affinity domain, thereby affinitizing the unit of memory with the second thread.

2. The method of claim 1, further comprising:
the computer mapping a heap in the first affinity domain to a first memory associated with the first affinity domain; and
the computer allocating the unit of memory to a thread executing in the first affinity domain using the heap in the first affinity domain.

3. The method of claim 2, further comprising:
the computer directing the request to access the unit of memory from the second thread to the heap in the first affinity domain.

4. The method of claim 1, wherein the migrating includes making contents of the unit of memory available in a second unit of memory in a second memory associated with the second affinity domain.

5. The method of claim 1, wherein the determining further comprises:
the computer counting a number of times the request is received during a period; and
the computer evaluating whether the number of times the request is received exceeds a threshold, wherein the migrating is responsive to the evaluating being affirmative.

6. The method of claim 5, wherein the threshold is a count of local accesses to the unit of memory from the first thread in the first affinity domain.

7. The method of claim 1, wherein the determining further comprises:
the computer counting a number of times the request is received during a plurality of periods; and
the computer evaluating whether the number of times the request is received exceeds a count of local accesses to the unit of memory from the first thread in the first affinity domain during the plurality of periods.

8. The method of claim 1, wherein the determining further comprises:
the computer counting a number of times the request is received during a plurality of periods.

9. The method of claim 5, wherein the evaluating occurs after the end of the period.

10. The method of claim 1, wherein the first affinity domain includes a first processor in the computer and the second affinity domain includes a second processor in the computer, wherein the first and the second threads are threads of a multithreaded application executing in the computer, and wherein the first thread executes on the first processor concurrently with the second thread executing on the second processor.

11. A computer program product comprising one or more computer-readable tangible storage devices and computer-readable program instructions which are stored on the one or more storage devices and when executed by one or more processors perform the method of claim 1.

12. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

13. A computer program product for memory affinitization in a multithreaded environment, the computer program product comprising one or more computer-readable tangible storage devices, and program instructions stored on at least one of the one or more storage devices, the program instructions comprising:
first program instructions to receive at a first affinity domain formed in a computer, from a second thread executing in a second affinity domain, a request to access a unit of memory in the first affinity domain;
second program instructions to make a determination whether to migrate the unit of memory to the second affinity domain; and
third program instructions to migrate, responsive to the determination being affirmative, the unit of memory to the second affinity domain, thereby affinitizing the unit of memory with the second thread.

14. The computer program product of claim 13, further comprising:
fourth program instructions to map a heap in the first affinity domain to a first memory associated with the first affinity domain; and
fifth program instructions to allocate the unit of memory to a thread executing in the first affinity domain using the heap in the first affinity domain.

15. The computer program product of claim 14, further comprising:
sixth program instructions to direct the request to access the unit of memory from the second thread to the heap in the first affinity domain.

16. The computer program product of claim 13, wherein the third program instructions to migrate the unit of memory to the second affinity domain make contents of the unit of memory available in a second unit of memory in a second memory associated with the second affinity domain.

17. The computer program product of claim 13, wherein the second program instructions to make the determination whether to migrate the unit of memory to the second affinity domain count a number of times the request is received during a period and evaluate whether the number of times the request is received exceeds a threshold, and wherein the third program instructions to migrate the unit of memory to the second affinity domain are responsive to the number of times the request is received exceeding the threshold.

18. The computer program product of claim 13, wherein the program instructions are stored in the one or more computer-readable tangible storage devices in a data processing system, and wherein the program instructions are transferred over a network from a remote data processing system.

19. The computer program product of claim 13, wherein the program instructions are stored in the one or more computer-readable tangible storage devices in a server data processing system, and wherein the program instructions are downloaded over a network to a remote data processing system for use in a computer-readable tangible storage device associated with the remote data processing system.

20. A computer system for memory affinitization in a multithreaded environment, the computer system comprising one or more processors, one or more computer-readable memories, one or more computer-readable tangible storage devices, and program instructions stored on at least one of the one or more storage devices for execution by at least one of the one or more processors via at least one of the one or more memories, the program instructions comprising:
first program instructions to receive at a first affinity domain formed in a computer, from a second thread executing in a second affinity domain, a request to access a unit of memory in the first affinity domain;
second program instructions to make a determination whether to migrate the unit of memory to the second affinity domain; and
third program instructions to migrate, responsive to the determination being affirmative, the unit of memory to the second affinity domain, thereby affinitizing the unit of memory with the second thread.
